(19) United States
(12) Patent Application Publication
(10) Pub. No.: US 2008/0070767 A1
(43) Pub. Date: Mar. 20, 2008

(54) Method for loading and unloading of a machine tool with tools

(76) Inventors: Josef Muser, Seiersberg (AT); Armin Muser, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/898,191

(22) Filed: Sep. 10, 2007

(30) Foreign Application Priority Data
Sep. 14, 2006 (AT) A 1530/2006

(51) Int. Cl. B23Q 3/155

(52) U.S. Cl. 483/1; 483/59

(57) ABSTRACT

The present invention relates to a method for loading and unloading a machine tool with tools, the tools being stored in a tool store and being transported via a manipulation device, which is particularly movable along multiple axes, to a transfer position on the machine tool or in the machine tool and being removed therefrom after use, the tools being transported by a gripper device along at least one path in a first main movement direction and in at least one travel lane, which is formed by two rows spaced apart from one another and is inclined to the main movement direction. To shorten the tool changing times, a gripper device of the manipulation device is moved between a loading and unloading position of the tool along at least one continuously running, at least partially curved path.

### BACKGROUND OF THE INVENTION

The present invention relates to a method for loading and unloading a machine tool with tools, the tools being stored in a tool store and being transported via a manipulation device, which is particularly movable along multiple axes, to a transfer position on the machine tool or in the machine tool and being removed therefrom after use, the tools being transported by a gripper device along at least one path in a first main movement direction and in at least one travel lane, which is formed by two rows spaced apart from one another and is inclined to the first main movement direction, a gripper device of the manipulation device being moved between a loading and unloading position of the tool along at least one continuously running, at least partially curved path. Furthermore, the present invention relates to a device for performing the method.

In connection with automated loading and unloading of a machine tool in particular, such as a milling machine, receiving a prepared tool by a manipulation device provided with a gripper device with the aid of devices which are particularly automated and movable along multiple axes, upon which, after a movement of the manipulation device between a magazine or store to a transfer position on or in the machine tool, the supplied tool is deposited or situated in the machine tool and typically installed via a corresponding changing device from the receptacle—or transfer station—in the machine tool. Simultaneously with the receiving of a new tool, a tool used in an immediately preceding work step is deposited at the receptacle or transfer station or position by the changing device of the machine tool, and then received by the manipulation device, which is particularly movable along multiple axes, and returned to a store or magazine again. The movement of the gripper device typically occurs via simple linear axes (toothed racks, spindle or belt drives). A manipulation device of this type is known, for example, from AT 501.092 A2.

### DESCRIPTION OF PRIOR ART

CH 531 391 A5 describes a tool changing device on a machine tool, the gripper guides being curved. The curved path is achieved by the geometry of the lever guide path (curved path). The removal from a tool store along a curved path, as is described in CH 531 391 A5, is generally known, but may not be used in a matrix magazine to achieve 300 or more positions. Only the removal of a tool from a store is described in CH 531 391 A5, but not the further transfer to the machine. Using the disclosed apparatus, it is not possible to execute the crossing from the vertical into the horizontal path as a curve. Furthermore, the device known from CH 531 391 A5 is not suitable at all for use in a matrix magazine, because the insertion may only be implemented from one side. If such a gripper unit was used in a matrix magazine, the space required would increase by approximately 10 times, which would result in unacceptably high transfer times.

DE 10 2005 006 722 A1 describes a workpiece processing facility, tools being stored in a tool magazine and the tools being removed from a tool turret by a pivot lever.

Up to this point, using robots having rotation axes to achieve curved, round movements was known. However, the tools are situated relatively far from one another on a surface in a matrix magazine (because of the large number), so that such a robot must have relatively long levers. These levers would result in a very large space requirement. In addition, such a robot must have at least three servo axes (=3 joints) to reach all axes of a matrix store. The controller of such robots is also more complicated than that of robots having two linear axes.

Known methods for loading and unloading have at least one position between receiving a tool and depositing a tool, in particular in the event of a direction change, at which the gripper device must be braked to zero velocity and accelerated back therefrom. This braking and acceleration procedure has the disadvantage that the travel time of the manipulation device is delayed, which has a disadvantageous effect on the tool changing times.

In known matrix magazines, the storage spaces are situated in a rectangular raster. A travel lane for the manipulation device is exposed between two diametrically opposite rows of storage spaces, which is situated perpendicularly to a main movement direction of the manipulation device. To remove tools from the storage spaces or deposit them in the storage spaces, the manipulation device must first perform a movement in the main movement direction and then a further movement oriented perpendicularly thereto in the direction of the travel lane. The manipulation device is abruptly braked in the area of the direction change and then immediately—after completing the direction change—accelerated again. This braking and acceleration procedure has the disadvantage, however, that the travel time of the manipulation device is delayed, which has a disadvantageous effect on the tool changing times.

### SUMMARY OF THE INVENTION

The object of the present invention is to avoid these disadvantages and shorten the tool changing times.

This is achieved according to the present invention in that the gripper device is moved at essentially continuously running velocity, the gripper device being moved continuously between receiving a tool and depositing the tool and/or between depositing a tool and receiving a tool.

It is especially advantageous if the storage spaces of a row—viewed in a side view—are preferably situated offset to one another along a curved line.

Alternatively or additionally, the travel lane may be inclined at an angle <90° to the first main movement direction of the manipulation device.

The movement of the gripper device of the manipulation device runs along continuously curved paths during the tool change, by which abrupt velocity changes are avoided. The manipulation device therefore does not have to be abruptly braked or accelerated during the tool change. Dead times may thus be avoided and the tool changing times may be reduced.

### BRIEF DESCRIPTION OF THE DRAWINGS

The present invention is explained in greater detail in the following on the basis of the figures.

FIG. 1 shows a processing center having a system according to the present invention for loading and unloading a machine tool in a diagonal view;

FIG. 2 shows a detail of the tool store in a side view in an embodiment variant; and

FIG. 3 shows a detail of the tool store in a further embodiment variant.

### DETAILLED DESCRIPTION OF THE PREFERRED EMBODIMENTS

The processing center 1 comprises a machine tool 2, a tool store 3, formed in the exemplary embodiment by a matrix magazine, a manipulation device 4 for tools 5, and a tool changer 6. The tool store 3 has a number of openings 7 in corresponding storage elements for receiving tools 5. Multiple tools 5 are stored in an x-y coordinate system in the tool store 3.

The manipulation device 4, which is movable or pivotable along multiple axes x, y, z or directions, is used to remove the tools 5 from the tool store 3 and to transfer them to the tool changer 6, a first main movement in the horizontal direction x being indicated by the double arrow 9 and a second main movement in a direction y, which is inclined thereto, being indicated by the double arrow 10. The manipulation device 4 transfers or receives tools 5 to or from the tool changer 6, which has a changer circular head 12, pivotable around an axis 11, having two diametrically opposite grippers 13. The tool changer 6 places the tool 5 on the spindle 14 of the machine tool 2 or removes the tool 5 therefrom. To allow this, the changer circular head 12 of the tool changer 6 may perform thrust movements in the z direction.

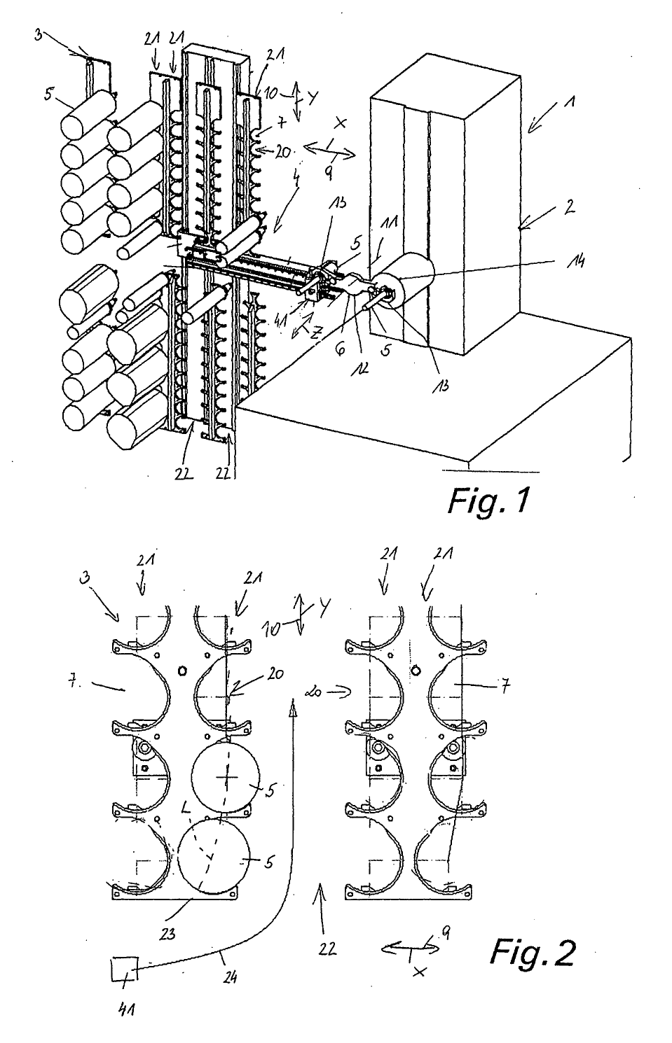

Each opening 7 defines a storage space 20 for tools 5. Multiple storage spaces 20 are each situated in a row 21 one on top of another. Each two rows of storage spaces 20 facing toward one another are spaced apart from one another and span a free travel lane 22 for the gripper device 41 of the manipulation device 4. The gripper device 41 may thus be guided in the vertical direction y between each two rows 21 through the travel lane 22. This allows it to be driven to each storage space 20 by travel movements in the x direction and y direction. In the known matrix magazine shown in FIG. 1, however, it is necessary for the gripper device 41 to be abruptly braked and just as suddenly accelerated again upon the transition from the x into the y movement and, vice versa, from the y into the x movement. This braking and acceleration has a disadvantageous effect on the tool changing times, however. Notwithstanding this, a large number of abrupt braking and acceleration movements and/or abrupt direction changes encourages wear of the manipulation device 4.

FIG. 2 shows an embodiment in which the storage spaces 20 are not situated linearly one on top of another, but rather are situated slightly offset to one another along a curved line L at least in the area of at least one end 23 of the rows 21. This allows the roundest possible travel movement along a continuously running path 24 of the gripper device 41, as indicated in FIG. 2. The gripper device 41 may thus, without stopping, be guided along a continuously curved curve in the running transition from the x direction into the y direction in the travel lane 22 and back out therefrom. Tool changing times may thus be shortened and the wear of the manipulation device 4 may be reduced.

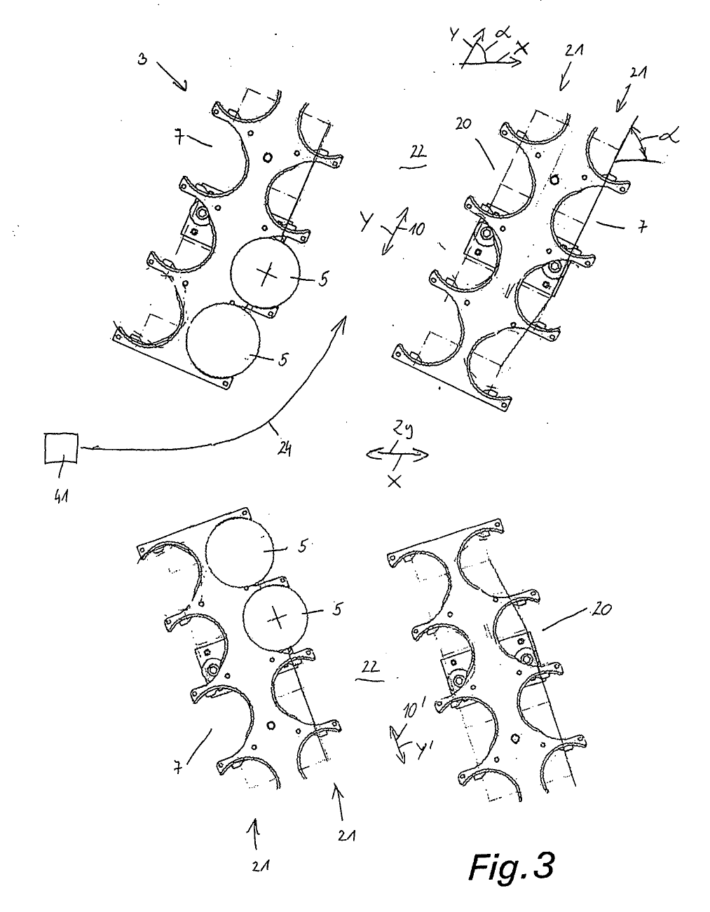

Alternatively or additionally to storage spaces laterally offset in the direction of the x axis, the rows 21 may also be situated inclined to the x direction. The rows 21 may also be situated in a V-shape to one another, as shown in FIG. 3. In this case, the gripper device 41 may be moved in the x direction, the y direction, and the y′ direction. Because the rows 21 are inclined to the x direction at an angle α<90°, a round travel movement along the path 24 is also possible in this case.

We claim:

1. A method for loading and unloading a machine tool with tools, the tools being stored in a tool store and being transported via a manipulation device, which is particularly movable along multiple axes, to a transfer position on the machine tool or in the machine tool and being removed therefrom after use, the tools being transported by a gripper device along at least one path in a first main movement direction and in a travel lane, which is formed by at least two rows spaced apart from one another and is inclined to the first main movement direction, a gripper device of the manipulation device being moved between a loading and unloading position of the tool along at least one continuously running, at least partially curved path, wherein the gripper device is moved at essentially continuously running velocity, the gripper device being moved continuously between receiving a tool and depositing the tool, or between depositing a tool and receiving a tool.

2. A device for loading and unloading a machine tool with tools, the tools being stored in a tool store and being transportable via a manipulation device, which is particularly movable along multiple axes, to a transfer position on the machine tool or in the machine tool and being removable therefrom after use in the machine tool, the tool store being implemented as a matrix store and having at least two rows of storage spaces, the tools being transportable by a gripper device along at least one path in a first main movement direction and in at least one travel lane, which is formed by two rows which are spaced apart from one another and is inclined to the main movement direction, wherein the path of the gripper device is implemented as continuously running and at least partially curved.

3. The device according to claim 2, wherein the storage spaces of a row—viewed in a side view—are preferably situated offset to one another along a curved line.

4. The device according to claim 2, wherein the travel lane is inclined at an angle <90° to the first main movement direction of the manipulation device.
